(19) United States
(12) Patent Application Publication
(10) Pub. No.: US 2023/0216352 A1
(43) Pub. Date: Jul. 6, 2023

(54) WIRELESS CHARGER ADAPTER

(71) Applicant: Datalogic IP Tech S.r.l., Calderara di Reno (IT)

(72) Inventor: Roberto Moschini, Bologna (IT)

(73) Assignee: Datalogic IP Tech S.r.l., Calderara di Reno (IT)

(21) Appl. No.: 17/569,418

(22) Filed: Jan. 5, 2022

(51) Int. Cl. H02J 50/40; H02J 50/10; H02J 50/00; H02J 7/00; H02J 50/80; H02J 50/90

(52) U.S. Cl. CPC H02J 50/40; H02J 50/10; H02J 50/005; H02J 7/0013; H02J 50/80; H02J 50/90; H02J 7/0044; H02J 7/007188

(57) ABSTRACT

A wireless charger adapter may include a structural member, a receive inductor coil supported by the structural member, an electrical circuit, and an output. The structural member may be placed in proximate location with a cradle of a wireless charging device inclusive of a transmit inductor coil. The receive inductor coil may inductively receive wireless power signals inductively transferred by the transmit inductor coil of the wireless charging device. The electrical circuit may convert the wireless power signals received by the receive inductor coil into electrical signals and the output may output the electrical signals from the electrical circuit to one or more external devices.

### BACKGROUND

Wireless power transfer systems include a wireless transmitting device and a wireless receiver device. The transmitting device generates a time-varying electromagnetic field that is used to transmit power wirelessly to the wireless receiver device. The wireless receiver device extracts power from the time-varying electromagnetic field and converts the power that is supplied to an electrical load. Wireless power transfer systems can eliminate the need for wires and electrical conductive contacts, which can increase mobility and convenience for users of the wireless power transfer systems. Wireless power transfer systems may be categorized as either near field (inductive) or far-field (resonant). In inductive wireless power transfer systems, power is transferred over short distances by magnetic fields using inductive coupling between a transmitting coil and a receiving coil. Inductive wireless power transfer systems are most commonly used in wireless technology.

Conventional inductive wireless power transfer systems often require a perfect alignment between the transmitter and receiver coils in order to enable power transfer (at least with sufficient power transfer) to perform desired functionality, such as charging a rechargeable battery. One problem with such a configuration is that the precision of alignment can limit the structural geometry of the wireless power transfer system, as the transmitting coil and the receiving coil must be mechanically placed at a specific position relative to one another. In other words, conventional inductive wireless power transfer systems are specifically designed for one particular device or application and may not be capable of supporting other devices or applications. As such, there is a need for a more versatile wireless power transfer system that is capable of providing power transfer to any number of devices or applications through inductive coupling.

### SUMMARY

To overcome the shortcomings of conventional inductive wireless power transfer systems, such as a cradle-shaped wireless power transfer system for recharging a barcode scanner, for example, a wireless charger adapter or wireless adapter may be utilized. The wireless charger adapter may be configured to be placed in proximate location to a wireless charging device having an inductive transmit coil. One embodiment of a wireless charging device may include a cradle for receiving and charging a barcode scanner. The wireless charger adapter may include a receiving inductor coil, which can inductively receive wireless power signals transferred by the transmit coil of the wireless charging device. The wireless charger adapter may include an electrical circuit to transform the wireless power signals to electrical signals. The wireless charger adapter may include at least one output port, adapter antenna, and/or second transmitting coil to receive and/or output wireless signals so that the wireless charger adapter can facilitate power transfer between the wireless charging device and a secondary device, even if the secondary device does not mechanically align with the wireless charging device. Because the wireless power transfer system may provide for a data communications channel, the wireless charger adapter may be configured to support data communications channel, as well.

One embodiment of a wireless adapter may include a structural member configured to be placed in proximate location with a cradle (housing) of a wireless charging device. The wireless charging device may be inclusive of a transmit inductor coil. The wireless adapter may further include a receive inductor coil supported by the structural member, and configured to inductively receive wireless power signals inductively transferred by the transmit inductor coil of the wireless charging device. The wireless adapter may further include an electrical circuit configured to convert the wireless power signals received by the receive inductor coil into electrical signals. The wireless adapter may further include an output configured to output the electrical signals from the electrical circuit to one or more external devices.

One embodiment of a system may include a barcode scanner having a first receive inductor coil and a wireless charging device provided in a housing and inclusive of a transmit inductor coil. The barcode scanner is configured to interface with the housing to inductively receive power via the first receive inductor coil from the transmit inductor coil. The system may include a wireless adapter, where the wireless adapter may include a structural member configured to be placed in proximate relation with a cradle of a wireless charging device. The wireless charging device may be inclusive of a transmit inductor coil. The wireless adapter may further include a receive inductor coil supported by the structural member, and configured to inductively receive wireless power signals inductively transferred by the transmit inductor coil of the wireless charging device. The wireless adapter may further include an electrical circuit configured to convert the wireless power signals received by the receive inductor coil into electrical signals. The wireless adapter may further include an output configured to output the electrical signals from the electrical circuit to one or more external devices

One embodiment of a method may include receiving, by a wireless adapter including a receive coil, wireless power from a wireless charging device including a transmit coil. The method further includes receiving, by the wireless adapter, a data signal from a barcode scanner. The data signal may be transmitted by the wireless adapter to the wireless charging device via a data channel between the adapter and the wireless charging device.

### BRIEF DESCRIPTION OF THE DRAWINGS

Illustrative embodiments of the present invention are described in detail below with reference to the attached drawing figures, which are incorporated by reference herein and wherein:

FIG. 1 is an illustration of a barcode scanner cradle, according to an illustrative embodiment;

FIG. 2 is an illustration of a barcode scanner cradle, according to an illustrative embodiment;

FIG. 3 is an illustration of a wireless charging system, according to an illustrative embodiment;

FIG. 4 is an illustration of a wireless charging system, according to an illustrative embodiment;

FIG. 5 is an illustration of a wireless charging system, according to an illustrative embodiment;

FIG. 6 is an illustration of a block diagram of a wireless charging system, according to an illustrative embodiment; and

FIG. 7 is a flow diagram of an illustrative process for transmitting data and power from a wireless charging device, according to an illustrative embodiment.

### DETAILED DESCRIPTION

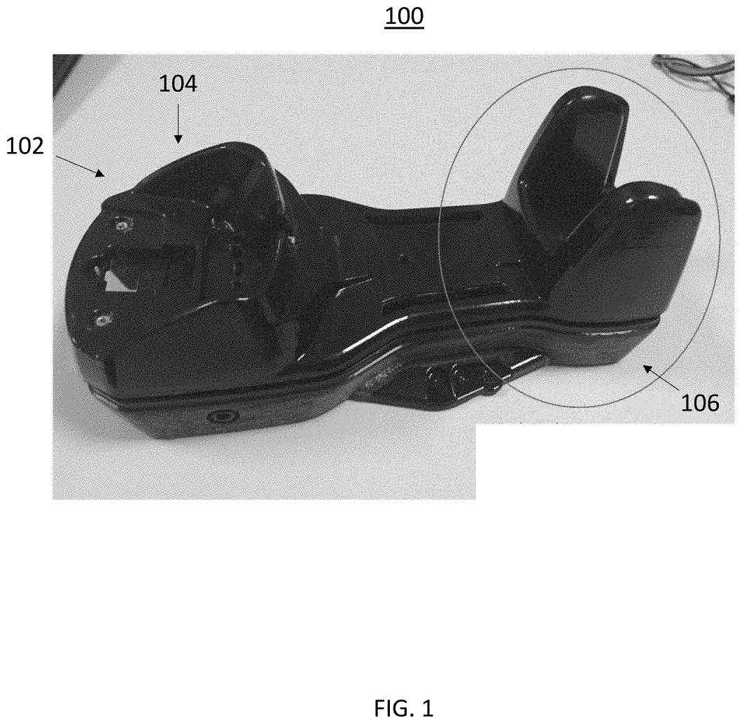

FIG. 1 is an illustration of a portion of a system 100 that includes a wireless charging device 102. For example, the wireless charging device 102 may be or may include any device capable of providing power wirelessly (e.g., inductively via a transmit inductor coil) to a secondary device. In some cases, the wireless charging device 102 may be or may include a cradle to receive and provide power to a scanner or imager of machine-readable indicia (e.g., barcodes), such as a barcode scanner, Near-field Communication (NFC) reader, or a radio frequency identification reader (RFID reader) (not shown). Other wireless charging devices with cradles may include portable telephones with wireless charging coils. For illustrative purposes, the wireless charging device 102 is described herein as supporting a barcode scanner. It should be understood that the wireless charging device 102 may be configured to receive and/or provide power to various other devices, such as scanners or imagers. The wireless charging device 102 may include a first end 104 and a second end 106. In some cases, the first end 104 may oppose the second end 106, as shown in FIG. 1. The first end 104 may receive a first portion (e.g., an end including an imaging device) of a barcode scanner (not shown) and the second end 106 may receive a second portion (e.g., an end having a handle) of the barcode scanner. Upon receiving the barcode scanner, the wireless charging device 102 may be configured to charge the barcode scanner by electrically sensing a receive coil being placed in inductive proximity with a transmit coil) within the wireless charging device 102 or causing a switch to activate the wireless power transfer, or otherwise by simply placing the barcode scanner onto the charging device 102 that is always applying wireless power from the transmit coil.

The wireless charging device 102 may be configured to provide the barcode scanner wireless electrical charge to recharge a rechargeable battery, for example. The second end 106 may include one or more transmit coils (not shown, but positioned within regions defined by a housing). The transmit coils may include inductors, antennas, or any other devices or components configured to wirelessly transmit power over a distance. Similarly, the barcode scanner may include one or more receive coils. The receive coils may include inductors, antennas, or any other devices or components configured to wirelessly receive power over a distance. To transfer power from the wireless charging device 102 to the barcode scanner, the barcode scanner and/or the wireless charging device 102 may be designed or be configured such that the barcode scanner aligns with a portion of the wireless charging device 102 (e.g., such that the transmit coil aligns with a receive coil within the barcode scanner). For example, upon receiving the second portion of the barcode scanner at the second end 106 of the wireless charging device 102, a transmit coil of the wireless charging device 102 may be aligned with a receive coil of the barcode scanner, thereby causing wireless power signals to be inductively transferred to the receive coil of the barcode scanner and thereby charge the barcode scanner (e.g., charge one or more rechargeable batteries or other power sources of the barcode scanner). In some embodiments, the receive coil of the barcode scanner may be in alignment with one or more portions of the second end 106 of the wireless charging device 102 (e.g., which corresponds to a location of the transmit coil of the wireless charging device 102) when the barcode scanner is positioned on the wireless charging device 102. When the receive coil of the barcode scanner is in alignment with the transmit coil, the transmit coil may be inductively (or electrically) coupled with the receive coil to facilitate transfer of power between the wireless charging device 102 and the barcode scanner. It should be understood that the first receive coil extending within the barcode scanner may include more than one receive coil. It should also be understood that the wireless charging device 102 may include a variety of other configurations to provide an electrical charge to the barcode scanner. Still yet, if a data communications channel exists to download data, for example, data signals may be communicated therebetween.

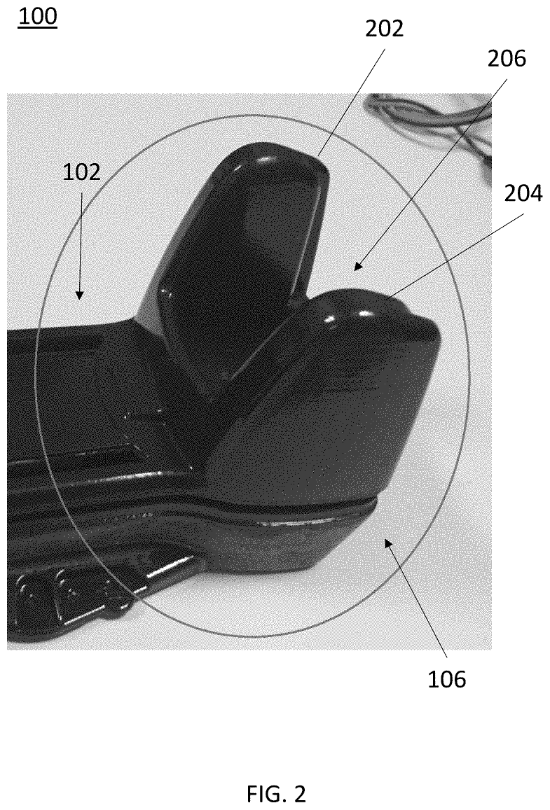

FIG. 2 is an illustration of a portion of the wireless charging device 102. Specifically, FIG. 2 depicts a close-up view of the second end 106 of the wireless charging device 102, which may receive a portion of a handle of the barcode scanner. The second end 106 may include a first extension 202 and a second extension 204. In some embodiments, either the first extension 202 or the second extension 204 may house the transmit coil to perform wireless charging. In some embodiments, both the first extension 202 and the second extension 204 may house respective transmit coils. The wireless charging device 102 can include a space 206 located at least partially between the first extension 202 and the second extension 204. Alternatively, the transmit coil(s) may be positioned beneath a base surface between the first and second extensions 202 and 204. For example, the space 206 may be or may include any opening, aperture, surface, or the like configured to receive a portion of the barcode scanner. In some embodiments, one or more walls, extensions, and/or protrusions may at least partially surround the space 206 such that movement of the barcode scanner is at least partially inhibited when the second end 106 receives the barcode scanner. As described above with reference to FIG. 1, the space 206 may define a surface contour which is complementary to a portion (e.g., the second portion) of the barcode scanner such that a receive coil within the barcode scanner is positioned in proximity to and substantially aligned with at least one transmit coil located within the first extension 202 and/or the second extension 204. The space 206 may be configured to receive another component of the system 100. For example, the space 206 may be configured to receive a portion of a wireless charger adapter 302, as will be described in greater detail herein.

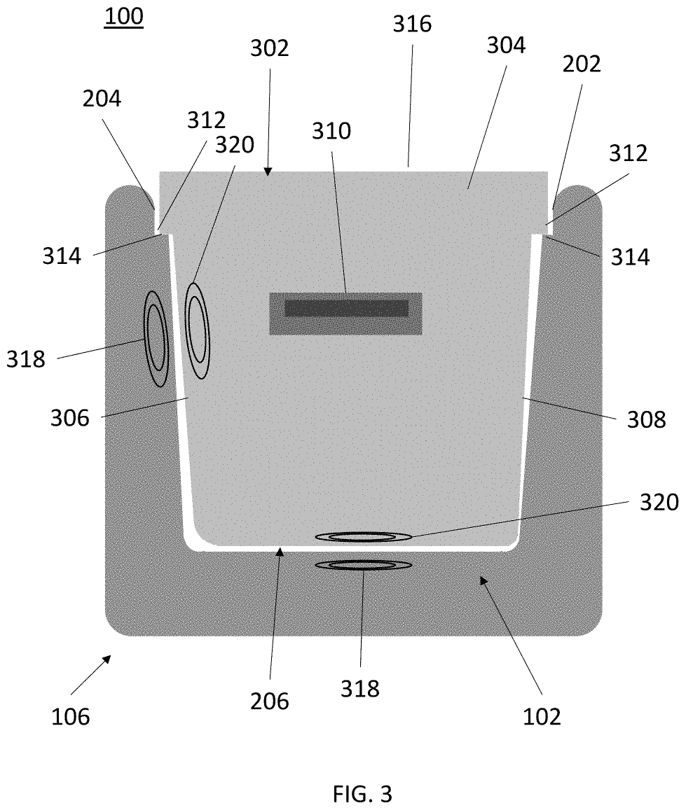

FIG. 3 is a rear view of the second end 106 of the wireless charging device 102. As shown in FIG. 3, the wireless charger adapter 302 may position within and/or position proximate (e.g., on top of, adjacent to, etc.) the space 206 between the first extension 202 and the second extension 204. In the adapter 302 being in proximate location or position with the wireless charging device 102, the two devices 302 and 102 are to be close enough to enable inductive charging to occur. In some embodiments, the wireless charger adapter 302 may include a housing with a profile that reflects the profile of housing that defines the space 206 between the first extension 202 and the second extension 204. For example, the wireless charger adapter 302 may include a specific geometric structure that is configured to conform to (i.e., is complementary to) a portion of the wireless charging device 102. In some embodiments, the wireless charger adapter 302 may include at least one portion that extends substantially parallel with a portion of the wireless charging device 102 in which a wireless transmit coil 318 is positioned. For example, the wireless charger adapter 302 may include a housing 304 that may be or may include a structural member to house and/or support the components of the wireless charger adapter 302 (e.g., such a receive coil 320 described in greater detail below). The housing 304 may include at least one surface that extends substantially parallel to a portion of the first extension 202 of the wireless charging device 102. For example, a first wall 306 of the housing 304 may extend substantially parallel to an interior-facing surface (e.g., facing the space 206) of the first extension 202 of the wireless charging device, and a second wall 308 may extend substantially parallel to an interior-facing surface (e.g., facing the space 206 and opposite the interior-facing surface of the first extension 202) of the second extension 204. It should be noted that the housing 304 may include a variety of shapes. For example, in some embodiments, the housing 304 may include additional or less walls (e.g., heptagonal in shape) than that shown in FIG. 3. In some embodiments, the housing 304 may include one or more rounded or arcuate portions to facilitate coupling and alignment with the wireless charging device 102.

The first wall 306 of the housing 304 of the wireless charger adapter 302 may be non-planar in some embodiments. For example, the first wall 306 may include at least one portion that is non-planar such that the non-planar portion may be configured to be positioned adjacent to and/or complementary to (e.g., interface with) the surface of the first extension 202. The second wall 308 of the housing 304 of the wireless charger adapter 302 may additionally and/or alternatively be non-planar portion. For example, the second wall 308 may include at least one portion that is non-planar such that the non-planar portion may be configured to position adjacent to and/or complementary to (e.g., interface with) the surface of the second extension 204. Various other portions of the housing 304 may include one or more non-planar portions to facilitate coupling and alignment with the wireless charging device 102.

The wireless charger adapter 302 may include one or more additional components to facilitate interfacing with the second end 106 of the wireless charging device 102. For example, the wireless charger adapter 302 may include one or more protrusions 312 that extend from a portion of the housing 304 to interface with a portion of the wireless charging device 102, such as a complementary inward-extending wall 314 of the first extension 202 and/or the second extension 204. The inward-extending wall 314 may protrude in an opposite direction as the protrusion 312 such that a bottom portion of the protrusion can interface with a top portion of the wall 314. In some embodiments, the protrusion 312 may engage with a portion of the inward-extending wall 314 of the wireless charging device 102 such that the contact between the protrusion 312 and the wall 314 facilitates maintaining the housing 304 in place within the space 206. In some embodiments, the housing 304 includes a substantially flat surface 316 at a top portion of the housing 304 as shown in FIGS. 3-5. The flat surface 316 may be sized to receive or otherwise support one or more devices (e.g., a device may be placed on top of and maintained on top of the housing 304). In some embodiments, the top surface of the housing 304 may include one or more curved or actuate portions (e.g., a different shaped cradle). It should be noted that the housing 304 may include a variety of geometric configurations to interface with one or more portions of the wireless charging device 102 and perform the same functions.

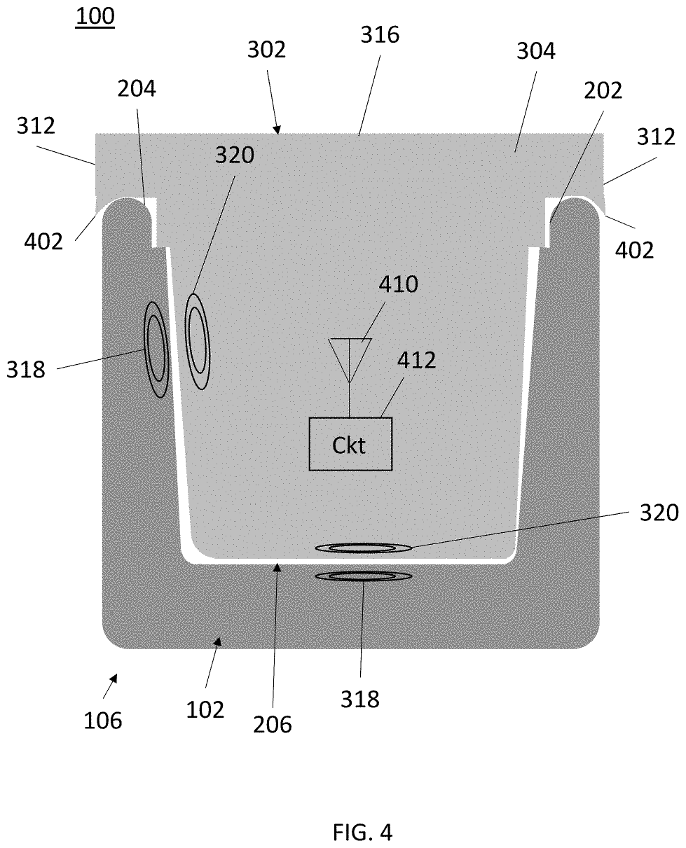

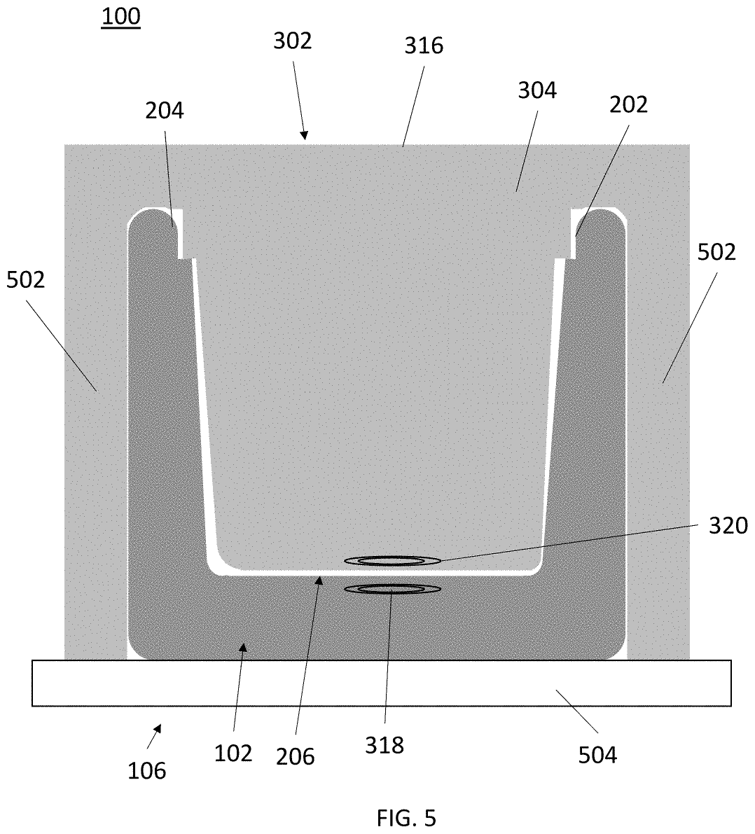

FIGS. 4 and 5 illustrate various configurations of the housing 304 of the wireless charger adapter 302 that interface with the second end 106 of the wireless charging device 102. For example, as shown in FIG. 4, the protrusions 312 may extend over a portion of one or both of the first extension 202 and the second extension 204. In some embodiments, the protrusion 312 may include at least one portion that mechanically aligns with a complementary portion of the wireless charging device 102. For example, in some embodiments, the first extension 202 and/or the second extension 204 may include an arcuate portion. In such embodiments, the protrusion 312 may include at least one complementary arcuate portion that may interface with the first extension 202 and/or the second extension 204. Similarly, in some embodiments, the first extension 202 and/or the second extension 204 may include a planar portion. In such embodiments, the protrusion 312 may include a complementary planar portion that may interface with the first extension 202 and/or the second extension 204. In some embodiments, one or more protrusions 312 may include at least one portion that extends around a portion of the first extension 202 and/or the second extension 204 to facilitate inhibiting movement and/or rotation of the housing 304. For example, as shown in FIG. 4, the protrusion 312 may include a hook portion 402 that at least partially surrounds and optionally rests on a portion of the first extension 202 and/or the second extension 204.

In some embodiments, the wireless charger adapter 302 may include one or more legs 502 that extend from a portion of the housing 304, as shown in FIG. 5. For example, the legs 502 can extend along the length of a portion of the wireless charging device 102. In some embodiments, the legs 502 may extend the same length as the longest portion of the first extension 202 and/or the second extension 204 (e.g., in a direction perpendicular to a direction extending between the first end 104 and the second end 106 of the wireless charging device 102). In some embodiments, the length of the legs 502 may exceed the length of the longest portion of the first extension 202 and/or the second extension 204 such that the legs 502 may engage with and/or interface with a support 504 positioned at a bottom portion of the wireless charging device 102. For example, the support 504 may be or may include a surface on which the wireless charging device 102 is positioned (e.g., a table, a desk, a floor, etc.). The legs 502 may contact with and/or engage with the support 504 to facilitate maintaining the housing 304 in place. The adapter 302 may extend over a portion or the entire wireless charging device 102. For example, the legs 502 may contact the support 504 such that rotation and/or movement of the housing 304 within and/or in proximity to the space 206 is at least partially inhibited. In some embodiments, the legs 502 may include one or more bent and/or arcuate portions (not shown) to reflect a profile of an external portion of the wireless charging device 102. Feet (not shown) may be positioned on a bottom surface of the legs, where the feet may be of a material (e.g., soft rubber, silicone, etc.) that resists scratching a surface and provides friction to the surface to resist movement.

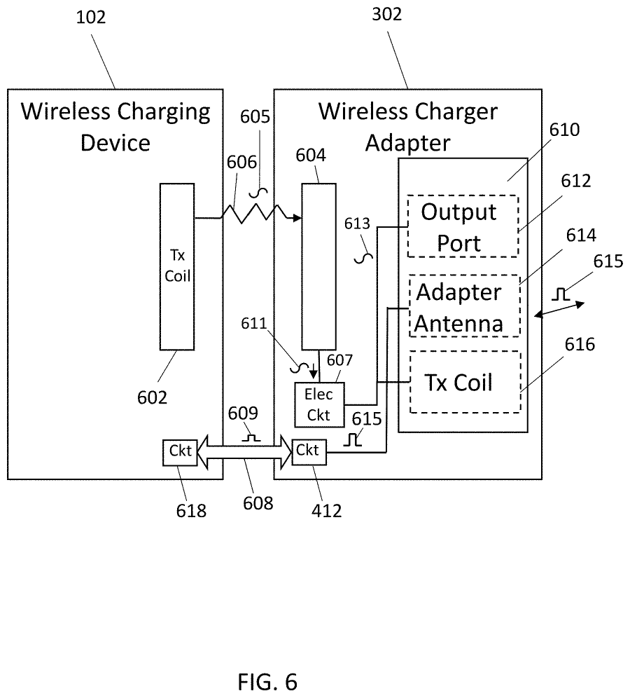

Referring to FIGS. 3-5 in connection with FIG. 6, the wireless charging device 102 may provide an electrical charge (e.g., electrical signals) to various different types of external devices via the wireless charger adapter 302. For example, the wireless charging device 102 may inductively transfer a wireless power signal 605 via a wireless power channel 606 to the wireless charger adapter 302. As described above, the wireless charger adapter 302 may be configured to align proximate or within the second end 106 of the wireless charging device 102. The wireless charger adapter 302 may include at least one wireless receive coil 604 (shown as coil 320 in FIGS. 3-5) configured to receive wireless power signals from a wireless transmit coil 602 (shown as coil 318 in FIGS. 3-5) of the wireless charging device 102. For example, the first extension 202 may include a first transmit coil 602 and/or the second extension 204 may include a second transmit coil 602. Alternatively, the wireless transmit coil 602 may be positioned beneath a flat surface between the extensions 202 and 204. In an embodiment, if the wireless charging device 102 has a single transmit coil, then only a single receive coil on one external device may inductively couple with the transmit coil at a time (i.e., device A may be inductively connected, device A may then be disconnected and device B may be inductively connected, etc.). In an embodiment in which multiple transmit coils exist, it may be possible to have multiple external devices be inductively coupled to the individual transmit coils at a time. It may also be possible to have an external device (e.g., multi-battery charger pack) with multiple receive coils in the embodiment in which the wireless charging device 102 includes multiple transmit coils, thereby increasing the amount of wireless power that may be received from the wireless charging deivce 102 to potentially increase speed of recharging rechargeable batteries, for example.

The receive coil 604 of the wireless charger adapter 302 may position along the first wall 306 and/or the second wall 308 of the housing 304 of the wireless charger adapter 302. Accordingly, upon placing the wireless charger adapter 302 with the one or more receive coils 604 of the wireless charger adapter 302 in proximity and oriented properly with a transmit coil 602 of the wireless charging device 102, the transmit coil 602 may transfer the wireless power signal via the wireless power channel 606 to the receive coil 604 of the wireless charging device 102. It should be understood that although the wireless charging device 102 and wireless charger adapter 302 have been described as utilize inductive charging, that alternative configurations may provide for resonant wireless charging, as described in co-pending U.S. patent application Ser. No. 17/551,025 filed on Dec. 14, 2021; the contents of which are incorporated herein by reference in their entirety.

The wireless charger adapter 302 may include outputs 610 configured to output electrical signals to one or more external devices. For example, the wireless charger adapter 302 may include one or more electrical circuits 607 that are configured to convert the wireless power signals 605 received by the receive coil 604 and transmitted to the electrical circuit 607 as signal 611 into electrical output signals 613 to provide an electrical charge to a device electrically coupled to the wireless charger adapter 302. In some embodiments, the wireless power signals 605 are communicated from the receive coil 604 to the electrical circuit 607 as electrical signals 611, which may provide the output signals 613 to a load (e.g., lamp). In some embodiments, the external device includes the load. As described in greater detail below, the load may be a rechargeable battery of an electronic device, a light source or lamp, a local barcode reader or scanner, one or more electronic devices coupled to the wireless charger adapter 302 via a universal serial bus (USB) or other port, to name a few possibilities and non-limiting examples. The wireless charger adapter 302 may be integrated into a base or other portion of an electrical device, such as a lamp, antenna, etc., as well.

Referring back to FIGS. 3 and 4, the wireless charger adapter 302 may include various configurations of outputs 610. For example, the outputs 610 may be or may include an output port 310, shown in FIG. 3, configured to output the electrical signals. The output port 310 may be or may include various standard output ports including, but not limited to, a Universal Serial Bus (USB) output port, a thunderbolt output port, a power outlet, an Ethernet output port, or the like. In some embodiments, the wireless charger adapter 302 may include a transmit coil (e.g., an adapter transmit coil 616 positioned within the housing 304 in addition to the adapter receive coil 604). The adapter transmit coil 616 may be configured to process and/or output wireless power signals 613 generated from the electrical signals 611 to one or more external devices having a receive coil (e.g., in a similar manner as shown and described in FIG. 6). In some embodiments, the adapter transmit coil 616 within the housing 304 of the wireless charger adapter 302 may be positioned adjacent to one or more interior walls of the housing 304 (e.g., just below the flat surface 316 shown in FIG. 3) such that a device having a receive coil positioned proximate the wall of the housing 304 may receive wireless power signals from the transmit coil 616 of the wireless charger adapter 302. It should be understood that alignment of the transmit coil 616 within the housing 304 and the external device may have a variety of configurations and provide the same on analogous functionality and/or electromagnetic properties. It should be understood that the wireless charger adapter 302 may have a number of different configurations and, optionally, be integrated into different external devices or accessories, where the different accessories may be configured to perform different functions (e.g., desk fan, desk light, clock, Internet radio, antenna, etc.). In cases where the adapter 302 is integrated into an accessory, the adapter 302 may simply power the accessory itself and not make power available to any other accessories, either via wire or wirelessly.

The wireless charger adapter 302 may include an adapter antenna 410, as shown in FIG. 4. For example, the adapter antenna 410 may be configured to transmit and/or receive wireless signals 615 to and/or from an external device. The adapter antenna 410 may be or may include various types of antennas including, but not limited to, dipole antennas, log printed antennas, array antennas, or the like to transfer and/or receive wireless signals 615, such as power and/or data signals, to an external device. In some embodiments, the wireless charger adapter 302 may include circuit 412 configured to boost a signal 613 sent or received via the adapter antenna 410. In other words, the wireless charger adapter 302 may include one or more antennas 410 such that the system 100 includes an additional antenna (e.g., in addition to one or more antennas already operably coupled to the wireless charging device 102) to increase the range of the one or more antennas of the wireless charging device 102. For example, an antenna of the wireless charging device 102 may include a gain of about 2 decibels per isotropic dB (dBi) without the wireless charger adapter 302.

Upon receiving the wireless charger adapter 302 in proximity to the space 206 of the wireless charging device 102, the adapter antenna 410 may be configured to receive wireless data signals 615 from another device in an environment of the wireless charger adapter 302 and transfer the wireless data signals 615 back to the wireless charging device 102 through circuits 412, 618 across data channel 608 (e.g., as the wireless signal 609). Such implementations may provide for an increase in gain of the wireless charging device 102 (e.g., gain that is greater than 2 dBi, such as 20dBi). It should be understood that the wireless charging device 102 and the adapter antenna 410 may include a significantly greater gain. This example is for illustrative purposes only. Moreover, an adapter transceiver and amplifier circuit 412 may boost power of data signals received from the wireless charging device 102 for communication by the adapter 302 with more power, thereby communicating a longer distance than possible by the wireless charging device 102.

The adapter antenna 410 may be configured to receive wireless signals from a device other than the wireless charging device 102, such as the barcode scanner that is configured to align with the wireless charging device 102. For example, the adapter antenna 410 may be configured to receive one or more wireless signals from the barcode scanner associated with the wireless charging device 102, and transmit the wireless signals 609 to the wireless charging device 102 through one or more data channels 608 between the wireless charger adapter 302 and the wireless charging device 102, as described in greater detail with reference to FIG. 6 herein.

The wireless charger adapter 302 may be configured to transfer electrical power and data to any number of external devices through the outputs 610 (FIG. 6). For example, the wireless charger adapter 302 may be configured to transfer signals to various lighting components (e.g., lamps), various electronic devices (e.g., mobile devices, smart watches, audio devices, etc.), desk fun (e.g., ferris wheel, spinning globe, multi-rechargeable battery pack charger, etc.) and/or similar devices. In some embodiments, the wireless charger adapter 302 may be configured to transfer power wirelessly to the one or more external devices. For example, as described above, the wireless charger adapter 302 may include an adapter transmit coil 616 to wirelessly transfer electrical signals to the external devices.

In some embodiments, the adapter transmit coil 616 may be located along a top or top-most portion of the housing 304 of the wireless charger adapter 302 such that the adapter transmit coil 616 is located proximate the top flat surface 316 of the housing 304 shown in FIG. 3. In such implementations, the flat surface 316 may receive a portion of the external device (e.g., a mobile device, watch, lighting component, etc.) placed on top of the flat surface 316 having a receive coil that may receive wireless signals from the adapter transmit coil 616 of the wireless charger adapter 302 for powering the external device. A wire line connection may alternatively be possible via a connector on the adapter 302. In some embodiments, a transmit coil may be located proximate one or more sidewalls of the housing 304 (e.g., the portion of the housing 304 having the output port 310 shown in FIG. 3) such the transmit coil of the wireless charger adapter 302 may transfer wireless signals to the external device upon receiving a portion of the external device adjacent the wall (e.g., a mobile device, watch, etc. set next to and/or up against the housing 304). A mount for retaining the external device in proximate location to one or more adapter transmit coils may be positioned on the housing 304.

In some embodiments, the wireless charger adapter 302 may be configured to transmit electric signals through one or more wires and/or cables. For example, as described above, the wireless charger adapter 302 may include one or more output ports 310 configured to transmit signals to the external devices. The output ports 310 may be configured to transmit signals to the external device upon receiving a complementary cable communicably coupled to the external device (e.g., a USB cable electrically coupled to the output port 310 and to the device). The wireless charger adapter 302 may be configured to transmit electrical signals to one or more rechargeable power sources. For example, the wireless charger adapter 302 may be configured to transmit electric signals to a rechargeable battery pack or similar device through one or more cables electronically coupled to the wireless charger adapter 302 and/or the rechargeable battery pack, such as an Ethernet or USB cable. The wireless charger adapter 302 may be integrated into a multi-battery charger to recharge rechargeable battery packs.

FIG. 6 is a schematic of an illustrative electrical system 100 of the wireless charging device 102 and wireless shown in FIG. 1-5. For example, the electrical system 100 may include the wireless charging device 102 (e.g., a receiver and/or cradle for a barcode scanner) having at least one transmit coil 602 and the wireless charger adapter 302 having at least one receive coil 604. As described above, the wireless charger adapter 302 includes outputs 610. The outputs 610 may be or may include any of an output port 612 (described above as output port 310 with reference to FIG. 3), an adapter antenna 614 (described above as adapter antenna 410 with reference to FIG. 4), and/or an additional adapter transmit inductor coil 616.

As depicted, the wireless charging device 102 may transmit wireless power signals 605 to the wireless charger adapter 302 via a wireless power channel 606 (e.g., via an inductive electromagnetic field). In some embodiments, the wireless charging device 102 may additionally and/or alternatively transmit and/or receive data signals 609 via a data channel 608 (e.g., via one or more antennas, antenna array systems, Bluetooth, endpoints or data terminals of the wireless charging device 102 and the wireless charger adapter 302, etc.). In other words, the data channel 608 may include either or both wired (e.g., contact-based) and wireless data connections. For example, as described above, the wireless charger adapter 302 may be configured to transmit and/or receive the wireless data signals 609 to and/or from the wireless charging device 102 via the data channel 608 through the adapter antenna 614. In some embodiments, the wireless data signals 609 transmitted via the adapter antenna 614 may be received from the barcode scanner associated with the wireless charging device 102. In some embodiments, the adapter antenna 614 may transmit and/or receive data signals 609 via the data channel 608, convert the data signals 609 (e.g., boost or reduce power) into data signals 614, and communicate the data signals 615 to or from one or more external devices including, but not limited to, an NFC reader, a secondary barcode reader, a QR code reader, or other device (e.g., digital clock). For example, the wireless data signals 609 may include, but are not limited to, data corresponding to machine-readable indicia scanned by an imaging device of the barcode scanner.

In some embodiments, the wireless charger adapter 302 may be configured to transmit and/or receive the data signals 609 to and/or from the wireless charging device 102 via the data channel 608 through the output port 612. An external device may electrically couple to the output port 612 via one or more cables (e.g., a USB) that includes a data line to form the data channel 608. For example, the wireless charger adapter 302 may be configured to transmit the data signals 615 (e.g., information related to machine-readable indicia scanned by the barcode scanner) from the wireless charging device 102 to a mobile device electrically coupled to or in communication with the adapter antenna 614. It should be noted that the wireless charger adapter 302 may be configured to transmit and/or receive the data signals 615 from various other devices.

In some embodiments, the wireless charger adapter 302 may be configured to modify (e.g., increase or decrease voltage, convert from AC to DC, etc.) the electrical signals 611 based on a type of external device electrically coupled to the output 610. The wireless charger adapter 302 may include electrical power converter or conditioning circuity designed or implemented to step-up or step-down a voltage, amperage, or wattage based on a device type for the external device. For instance, the wireless charger adapter 302 may be configured to receive (e.g., via a data channel or other communication channel) from the external device, a power requirement (e.g., power type, power level, etc.) for the external device. The wireless charger adapter 302 may be configured to modify the output to the external device based on the power requirement of the external device. In other words, the electrical circuit 607 of the wireless charger adapter 302 may be configured to dynamically and automatically modify the output power of the electrical signals 611 to produce electrical signals 613 depending on the configuration of the external device. In some embodiments, the wireless charger adapter 302 may include one or more voltage regulators, voltage optimizers, voltage stabilizers, or voltage correctors to facilitate modifying the electrical circuit. By way of example, the electrical circuit 607 of the wireless charger adapter 302 may be configured to output a voltage of about 5V (e.g., between 3V-8V, for instance) for a mobile device electrically coupled to the output 610. As another example, the electrical circuit of the wireless charger adapter 302 may be configured to output a voltage of about 20V (e.g., between 10V-30V, for instance) for a larger computing device (e.g., a laptop) electrically coupled to the output 610. It should be noted that these examples are for illustrative purposes only. The electrical circuit 607 of the wireless charger adapter 302 may accommodate various other circumstances and/or devices.

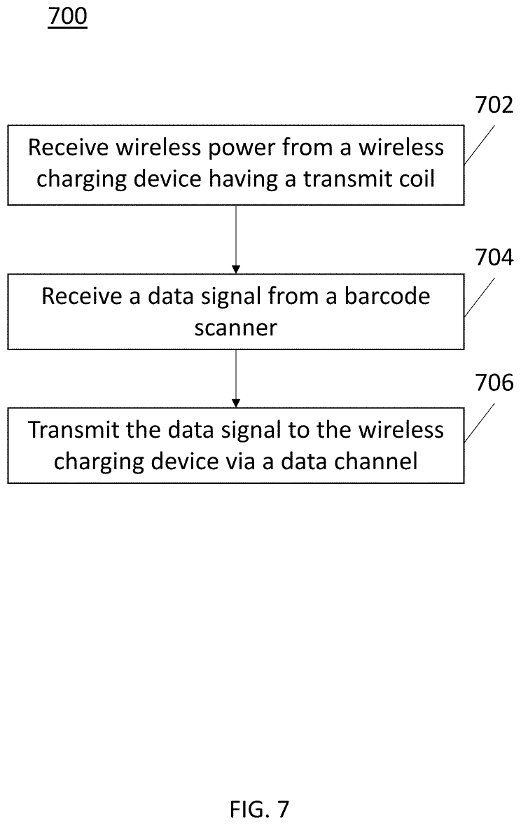

FIG. 7 is an illustration of a flowchart of a method 700 of transmitting data and/or power from a wireless charging device. For example, the method 700 may include receiving, by a wireless charger adapter, wireless power signals from the wireless charging device at step 702. For example, as described above with reference to FIGS. 1-6, the wireless charging device 102 may include at least one transmit coil 602 to inductively or otherwise wirelessly transfer power signals to at least one receive coil 604 within the housing 304 of the wireless charger 302. The transmit coil 602 may be positioned internal to and proximate with a first exterior wall of the wireless charging device 102 (e.g., within first extension 202 and/or second extension 204 of the wireless charging device 102). The receive coil 604 may be positioned internal to and proximate with (e.g., adjacent) a first exterior wall of the wireless charger adapter 302 (e.g., within the housing 304 and proximate with the first wall 306 and/or the second wall 308 of the housing 304) such that the transmit coil 602 of the wireless charging device 102 aligns with the receive coil 604 of the wireless charger adapter 302 upon placing the wireless charger adapter 302 in proximity to the first extension 202 and the second extension 204 of the wireless charging device 102. If a resonant inductive wireless power transfer is utilized, then less stringent alignment is needed for the wireless power transfer.

At step 704, the wireless charger adapter 302 may receive a data signal from a barcode scanner. For example, the wireless charger adapter 302 may receive one or more wireless data signals from the barcode scanner via the adapter antenna 614. As described above, the adapter antenna 614 of the wireless charger adapter 302 may have a greater wireless range than the wireless range of the wireless charging device 102 such that the wireless charger adapter 302 facilitates extending the wireless range of the wireless charging device 102 to (e.g., to receive data signals from the barcode scanner associated with the wireless charging device 102, even when the wireless charging device 102 is not capable of receiving data signals).

In some embodiments, the wireless charger adapter 302 may have a wireless range that is greater than a wireless range of the wireless charging device 102. For example, if the wireless charging device 102 has a wireless range of about 100 meters (e.g., via an antenna of the wireless charging device 102), the wireless charger adapter 302 may have a wireless range greater than 100 meters (e.g., via an amplifier and the adapter antenna 614), such as 300 meters. It should be noted that this range is for illustrative purposes only. The wireless charging device 102 and wireless charger adapter 302 may have significantly greater and/or significantly lesser wireless ranges.

At step 706, the wireless charger adapter may transmit the data signal to the wireless charging device via a data channel between the wireless charger adapter and the wireless charging device. For example, as described above, the wireless charger adapter 302 may be configured to transmit and/or receive wireless data signals to and/or from the wireless charging device 102 via the data channel 608 through the adapter antenna 614.

The foregoing method descriptions and the process flow diagrams are provided merely as illustrative examples and are not intended to require or imply that the steps of the various embodiments must be performed in the order presented. As will be appreciated by one of skill in the art the steps in the foregoing embodiments may be performed in any order. Words such as “then,” “next,” etc. are not intended to limit the order of the steps; these words are simply used to guide the reader through the description of the methods. Although process flow diagrams may describe the operations as a sequential process, many of the operations may be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the principles of the present invention.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

The previous description is of a preferred embodiment for implementing the invention, and the scope of the invention should not necessarily be limited by this description. The scope of the present invention is instead defined by the following claims.

What is claimed:

1. A wireless adapter, comprising:
a structural member configured to be placed in proximate relation with a cradle of a wireless charging device inclusive of a transmit inductor coil;
a receive inductor coil supported by the structural member, and configured to inductively receive wireless power signals inductively transferred by the transmit inductor coil of the wireless charging device;
an electrical circuit configured to convert the wireless power signals received by the receive inductor coil into electrical signals; and
an output configured to output the electrical signals from the electrical circuit to one or more external devices.

2. The wireless adapter of claim 1, wherein the output includes at least one of (i) an output port configured to output the electrical signals from the electrical circuit therefrom, (ii) a second transmit inductor coil configured to output second wireless power signals generated from the electrical signals to the one or more external devices inclusive of a second receive inductor coil, (iii) an adapter antenna configured to transmit or receive data signals, or (iv) a multi-battery charger.

3. The wireless adapter of claim 2, wherein the wireless adapter further includes electronics configured to amplify data signals, received from the wireless charging device the output includes the adapter antenna, and wherein the adapter antenna is configured to wireless transmit the amplified data signals with a longer range than the wireless charging device.

4. The wireless adapter of claim 3, wherein the wireless adapter is configured to receive the data signals via the adapter antenna from a barcode scanner and transmit the data signals to the wireless charging device via a data channel between the wireless adapter and the wireless charging device.

5. The wireless adapter of claim 1, wherein the structural member includes a non-planar surface at which the receive inductor coil is positioned and is complementary to a non-planar surface of the cradle at which the transmit inductor coil of the wireless charging device is positioned.

6. The wireless adapter of claim 5, wherein the receive inductor coil is substantially aligned with the transmit inductor coil of the wireless charging device when the structural member interfaces with the cradle of the wireless charging device.

7. The wireless adapter of claim 1, wherein the wireless charging device is configured to charge a barcode scanner when the barcode scanner is positioned in the cradle.

8. The wireless adapter of claim 1, wherein the electrical circuit is configured to modify an electrical output voltage of the electrical signals based on a device type of an external device electrically coupled to the output.

9. A system comprising:
a barcode scanner having a first receive inductor coil;
a wireless charging device including a housing and a transmit inductor coil disposed therein, the barcode scanner configured to interface with the housing to inductively receive power via the first receive inductor coil from the transmit inductor coil; and
a wireless adapter comprising:
a structural member configured to be placed in proximate location with at least a portion of the housing of the wireless charging device;
a second receive inductor coil supported by the structural member, and configured to inductively receive wireless power signals inductively transferred by the transmit inductor coil of the wireless charging device when the structural member is placed in proximate location with the housing of the wireless charging device;
an electrical circuit configured to convert the wireless power signals received by the receive inductor coil into electrical signals; and
an output configured to output the electrical signals from the electrical circuit to one or more external devices.

10. The system of claim 9, wherein the output of the wireless adapter includes at least one of (i) an output port configured to output the electrical signals from the electrical circuit therefrom, (ii) a second transmit inductor coil configured to output second wireless power signals generated from the electrical signals to the one or more external devices inclusive of a second receive inductor coil, (iii) an adapter antenna configured to transmit or receive data signals, or (iv) a multi-battery charger.

11. The system of claim 10, wherein the wireless adapter further includes electronics configured to amplify data signals received from the wireless charging device, the output comprises the adapter antenna, and wherein the adapter antenna is configured to wirelessly transmit the amplified data signal with a longer range than the wireless charging device.

12. The system of claim 11, wherein the wireless adapter is configured to receive the data signals via the adapter antenna from a barcode scanner and transmit the data signals to the wireless charging device via a data channel between the wireless adapter and the wireless charging device.

13. The system of claim 9, wherein the structural member includes a non-planar surface at which the receive inductor coil is positioned and is complementary to a non-planar surface of wireless charging device at which the transmit inductor coil of the wireless charging device is positioned.

14. The system of claim 13, wherein the receive inductor coil is substantially aligned with the transmit inductor coil of the wireless charging device when the structural member interfaces with the housing of the wireless charging device.

15. The system of claim 14, wherein the housing comprises a cradle configured to support the barcode scanner when the barcode scanner interfaces with the cradle, and wherein the cradle is further configured to support the wireless adapter when the wireless adapter interfaces with the cradle.

16. The system of claim 9, wherein the electrical circuit is configured to modify an electrical output voltage of the electrical signals based on a device type of an external device electrically coupled to the output.

17. The system of claim 9, wherein the wireless adapter is configured to transmit data to the wireless charging device via a data channel between the wireless adapter and the wireless charging device.

18. A method comprising:
receiving, by a wireless adapter including a receive coil, wireless power from a wireless charging device including a transmit coil;
receiving, by the wireless adapter, a data signal from a barcode scanner; and
transmitting, by the wireless adapter, the data signal to the wireless charging device via a data channel between the adapter and the wireless charging device.

19. The method of claim 18, wherein the data signal is wirelessly received from the barcode scanner.

20. The method of claim 19, wherein the wireless charging device has a first wireless range for communicating the data signal and wherein the wireless adapter has a second wireless range greater than the first wireless range for communicating the data signal.
